(19) United States
(12) Patent Application Publication
(10) Pub. No.: US 2015/0060007 A1
(43) Pub. Date: Mar. 5, 2015

(54) HEAT PUMP

(71) Applicant: Benson Global Pty Ltd., Subiaco, Western Australia (AU)

(72) Inventor: Steven Michael Smith, Subiaco (AU)

(73) Assignee: Benson Global Pty Ltd., Subiaco, Western Australia (AU)

(21) Appl. No.: 14/394,237

(22) PCT Filed: Apr. 15, 2013
(86) PCT No.: PCT/AU2013/000379

§ 371 Date: Oct. 13, 2014

(30) Foreign Application Priority Data
Apr. 13, 2012 (AU) 2012901464

(51) Int. Cl. F28F 27/02; H02J 3/46

(52) U.S. Cl. CPC F28F 27/02; H02J 3/46
USPC 165/10; 165/96; 165/287; 307/23

(57) ABSTRACT

A heat pump including a fluid circuit and a control arrangement. The fluid circuit includes a first heat exchanger, a second heat exchanger, a third heat exchanger and a driver for driving fluid about the fluid circuit. The control arrangement has one or more modes of operation. The first heat exchanger is arranged to exchange heat between the fluid of the fluid circuit and further fluid. The control arrangement is configured to in at least one of the modes of operation control a flow control mechanism to control a flow rate of the further fluid of the first heat exchanger.

### FIELD

This invention relates to energy efficiency. Various aspects of the invention provide heat pumps, methods of pumping heat, methods of managing demand for electricity and energy storage devices.

### BACKGROUND

The coefficient of performance (COP) is a measure of the performance of a heating and/or cooling system. COP is the ratio of useful heating or cooling to the amount of energy supplied. By way of example, in a simple water heater having a resistive electrical heating element, the water is heated by an amount equal to the amount of electrical energy supplied such that the COP is 1.

A simple air-conditioner is a form of heat pump. Various existing air-conditioners include a compressor, a first heat exchanger, an expansion valve and a second heat exchanger spaced about a fluid circuit. The compressor serves to drive a refrigerant about the fluid circuit and to compress the gaseous refrigerant. The compressor thus delivers hot high pressure refrigerant to the first heat exchanger.

The first heat exchanger is typically arranged in communication with outside air to effect heat exchange between the outside air and the refrigerant such that the refrigerant condenses and releases its latent heat to the outside air. The first heat exchanger is thus often referred to as a “condenser”. From the first heat exchanger the refrigerant passes through an expansion valve from which it is delivered at reduced pressure to the second heat exchanger.

The second heat exchanger is arranged to effect heat exchange between the refrigerant and the air in a dwelling whereby the cool low pressure refrigerant accepts heat from the air and evaporates so as to cool the air inside the dwelling. The second heat exchanger is often called an “evaporator”. From the second heat exchanger the refrigerant is returned to the compressor to complete the fluid circuit.

The coefficient of performance of such a heat pump is equal to the amount by which the air inside the dwelling is cooled to the amount of electrical energy consumed by the pump. Electrical energy is consumed by the compressor and any fans associated with the heat exchangers. Such heat pumps can have coefficient of performance well above 1.

In conventional electricity supply grids power is supplied from a variety of generators to a variety of geographically spaced consumers of electricity. The generators can include gas turbines, coal fired power stations, wind turbines, hydro-electric turbines etc. The consumers can include residencies and various businesses.

In such supply systems variations in demand can occur unexpectedly. Sudden reductions in demand for electricity typically leads to inefficiencies. Most generators cannot be efficiently deactivated instantaneously. The roll out of consumer level energy generation devices, e.g. solar panels on the rooves of homes is contributing to the frequency of rapid unexpected reductions in demand for electricity. By way of example, when clouds lift in a suburb in which many homes are fitted with solar panels, the homes have solar panels start drawing electricity from their own panels rather than from the grid.

As society is becoming more environmentally aware and energy is becoming more expensive, energy efficiency is becoming more important. It is an object of at least a preferred embodiment of the invention to provide improvements in energy efficiency or at least to provide an alternative for those concerned with energy efficiency.

It is not admitted that any of the information in this patent specification is common general knowledge, or that the person skilled in the art could be reasonably expected to ascertain or understand it, regard it as relevant or combine it in any way at the priority date.

### SUMMARY

One aspect of the invention provides a heat pump including

a fluid circuit including
a first heat exchanger;
a second heat exchanger;
a third heat exchanger; and
a driver for driving fluid about the fluid circuit; and

a control arrangement having one or more modes of operation;

wherein
the first heat exchanger is arranged to exchange heat between the fluid of the fluid circuit and further fluid; and
the control arrangement is configured to in at least one of the modes of operation control a flow control mechanism to control a flow rate of the further fluid of the first heat exchanger.

The control of the flow rate of the further fluid of the first heat exchanger is preferably dependent on a parameter characterising the further fluid of the first heat exchanger. Most preferably the parameter is temperature. Preferably the control arrangement is configured to when in another mode of operation to substantially stop the flow of the further fluid of the first heat exchanger.

Alternatively, the control of the flow rate of the further fluid of the first heat exchanger may be substantially stopping the flow of the further fluid of the first heat exchanger.

The heat pump may further include a sensor, for sensing a parameter characterising the fluid of the fluid circuit, in communication with the control arrangement. The sensed parameter is preferably temperature. In yet another alternative, the control of the flow rate of the further fluid of the first heat exchanger may be dependent upon the parameter.

In preferred forms of the invention the second heat exchanger is arranged to exchange heat between the fluid of the fluid circuit and further fluid; and

the control arrangement is configured to in at least one of the modes of operation control a flow control mechanism to control a flow rate of the further fluid of the second heat exchanger.

The control of the flow rate of the further fluid of the second heat exchanger may be dependent on a or the parameter of the fluid of the fluid circuit.

In preferred forms of the invention the third heat exchanger is arranged to exchange heat between the fluid of the fluid circuit and further fluid; and

the control arrangement is configured to in at least one of the modes of operation control a flow control mechanism to control a flow rate of the further fluid of the third heat exchanger.

The control of the flow rate of the further fluid of the third heat exchanger may be dependent on a or the parameter of the fluid of the fluid circuit.

Preferably the driver and the first heat exchanger are spaced along a first portion of the fluid circuit;

the second heat exchanger and the third heat exchanger are spaced along a second portion of the fluid circuit; and

the first and second fluid circuit portions are connected by a valve arrangement configured to, in response to the control arrangement, reverse a direction of flow about the second fluid circuit portion.

The heat pump preferably includes an expansion valve along the fluid circuit and between the second heat exchanger and the third heat exchanger. The expansion valve may be controlled by the control arrangement to maintain a temperature, of the fluid of the fluid circuit as it enters the driver, above a saturation temperature of the fluid of the fluid circuit, or more preferably at or above about 5° C. above a saturation temperature of the fluid of the fluid circuit.

Preferably the further fluid of the first heat exchanger is water. According to preferred forms of the invention, the further fluid of the second heat exchanger is air, in which case the second heat exchanger may be arranged to at least one of accept heat from and reject heat to an environment external to a dwelling. It is also preferred that the further fluid of the third heat exchanger is air, in which case the third heat exchanger may be arranged to at least one of heat and cool an interior of a or the dwelling.

The fluid of the fluid circuit is preferably at least predominantly hydrocarbon, e.g. at least predominantly propane. Purified propane known as R290 is most preferred.

The heat pump may further include one or more photo-voltaic devices for powering the driver and the control arrangement, in which case the heat pump preferably further includes a device for storing electrical energy from the photo voltaic devices; wherein the control arrangement is configured to monitor the amount of energy stored in the device for storing electrical energy and activate the driver in response thereto.

Altervatively, the control arrangement may be configured to monitor the amount of energy stored in a device for storing electrical energy from one or more photo voltaic devices activate the driver in response thereto.

Another aspect of the invention provides a method of managing demand for electricity in an electricity supply system including one or more generators for supplying electricity to geographically spaced consumers of energy, the method including

in response to a sensed or predicted reduction in demand from the consumers for electricity, activating energy storage devices associated with the consumers to consume electricity.

By way of example, the consumers may include dwellings which each include one or more of the energy storage devices. Preferably one or more of the energy storage devices includes the above heat pump. The energy storage devices may be configured to heat water to store energy.

Another aspect of the invention provides an energy storage device including a communication mechanism for receiving an activation signal from a geographically distal controller. The device may include the heat pump of any one of claims 1 to 24. Optionally the device may be configured to heat water to store energy.

### BRIEF DESCRIPTION OF DRAWINGS

An embodiment of the apparatus will now be described by way of example only with reference to the accompanying drawings in which:

FIG. 1 schematically illustrates an exemplary heat pump; and

FIGS. 2 to 6 schematically illustrate key components of the heat pump of FIG. 1 in various operating modes.

### DETAILED DESCRIPTION

FIG. 1 illustrates an exemplary heat pump 10 which in its various modes of operation can respectively:
1. cool an inhabitable space;
2. heat a habitable space;
3. heat water;
4. simultaneously heat an inhabitable space and heat water; and
5. simultaneously cool an inhabitable space and heat water.

The principal components of the heat pump 10 are compressor 1, first heat exchanger 2, three way valve 3, second heat exchanger 6, expansion valve 5, third heat exchanger 4, controller 8 and temperature sensors 9A, 9B, 9C, 9E. The compressor 1, heat exchangers 2, 4 and 6, and expansion valve 5 are serially connected by conduit to form a fluid circuit 10A. The compressor 1 is a form of driver for driving refrigerant about the fluid circuit 10A.

The fluid circuit 10A is in two parts connected by the three way valve 3. A first portion of the fluid circuit 10A includes the compressor 1 and heat exchanger 2. The compressor 1 is upstream of the heat exchanger 2. In the other portion of the fluid circuit 10A, each of the heat exchanger 4 and 6 are respectively connected to the valve 3. The valve 5 is along a line connecting the heat exchanger 4 to the heat exchanger 6. The three way valve 3 is operable to reverse the direction of flow through this second portion of the fluid circuit 10A.

The heat exchangers may be spiral heat exchangers or plate heat exchangers. Preferably they are high efficiency heat exchangers. In this embodiment the fluid of the fluid circuit (i.e. the refrigerant) is propane. Propane has been found to have excellent properties as a refrigerant and to be better for the environment, both in terms of ozone damage and contribution to the greenhouse effect, than other refrigerants.

Temperature sensors 9A, 9B, 9C and 9E respectively provide indications of the temperature of the:
refrigerant at the inlet of the compressor;
refrigerant at the outlet of the compressor;
outside ambient air in the vicinity of the second heat exchanger 6; and
refrigerant at the inlet to the second heat exchanger 6.

A further temperature sensor 9D, which may or may not be part of the heat pump, provides an indication of the temperature of water exiting the second exchanger 2.

The heat exchanger 2, in some modes of operation, serves to heat water. The heat exchanger 4 in various modes of operation serves to heat or cool the interior of a dwelling. The heat exchanger 6 in various modes of operation serves to accept heat from or reject heat to air outside of the dwelling. The heat pump 10 further includes a fan 4A for driving air through the heat exchanger 4, and a fan 6A for driving air through the heat exchanger 6.

The controller 8 is operatively connected to the temperature sensors 9A, 9B, 9C, 9D and 9E to receive data therefrom, and to the compressor 1, valve 3, valve 5, fan 4A and fan 6A to send control signals thereto. The controller 8 is also operatively connected to a pump 2A, which may or may not be part of the heat pump 10, for driving water to be heated through the heat exchanger 2. Various modes of operative connection are contemplated, including both wired and wireless options.

The fans 4A, 6A and pump 2A are flow control mechanisms. Other flow control mechanisms, e.g. valves, are possible. The fans 4A, 6A and pump 2A control the flow rates of the non-refrigerant fluids through the heat exchangers.

In this embodiment the control arrangements are centralised in a single controller 8. It is also possible that the controller arrangements might be a plurality of separate control units. By way of example, the expansion valve 5 might, in a rudimentary form of the invention, simply respond to the temperature sensor 9A independently of other parameters and separately of other control arrangements.

The valve 3 has four ports. The valve receives refrigerant from heat exchanger 2 via port 51 and is communicated with the second heat exchanger 6 and the third heat exchanger 4 via ports 52 and 53 respectively. The valve 3 delivers refrigerant to the compressor 1 via port 54.

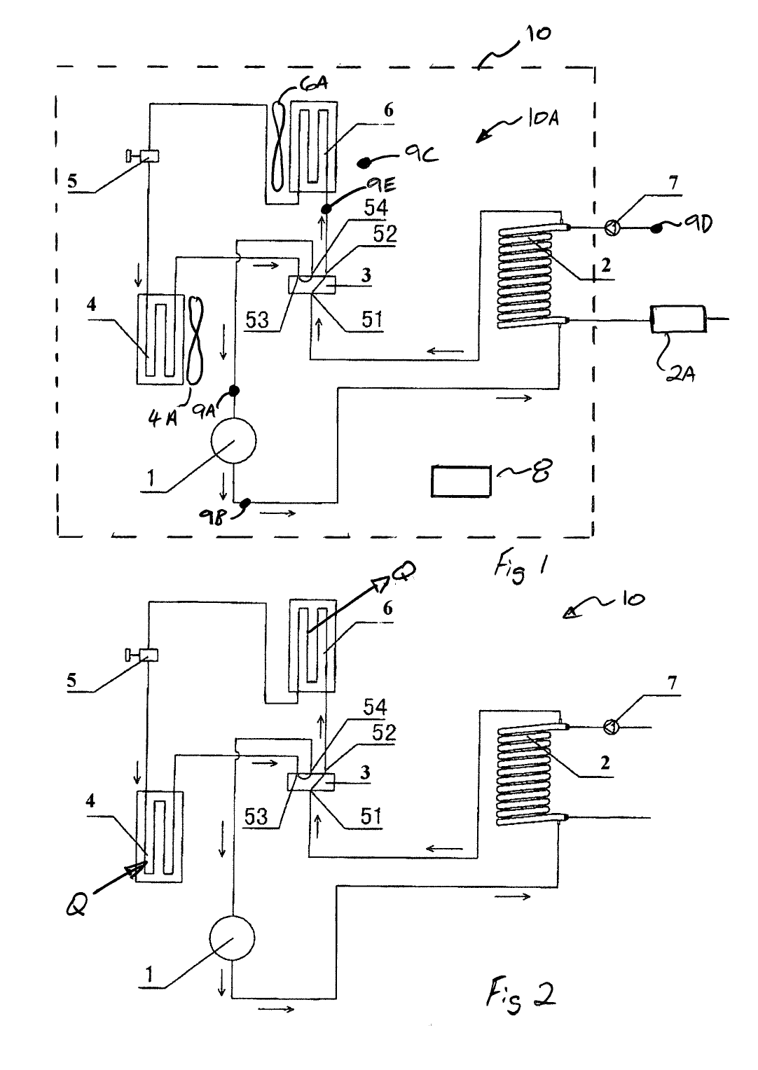

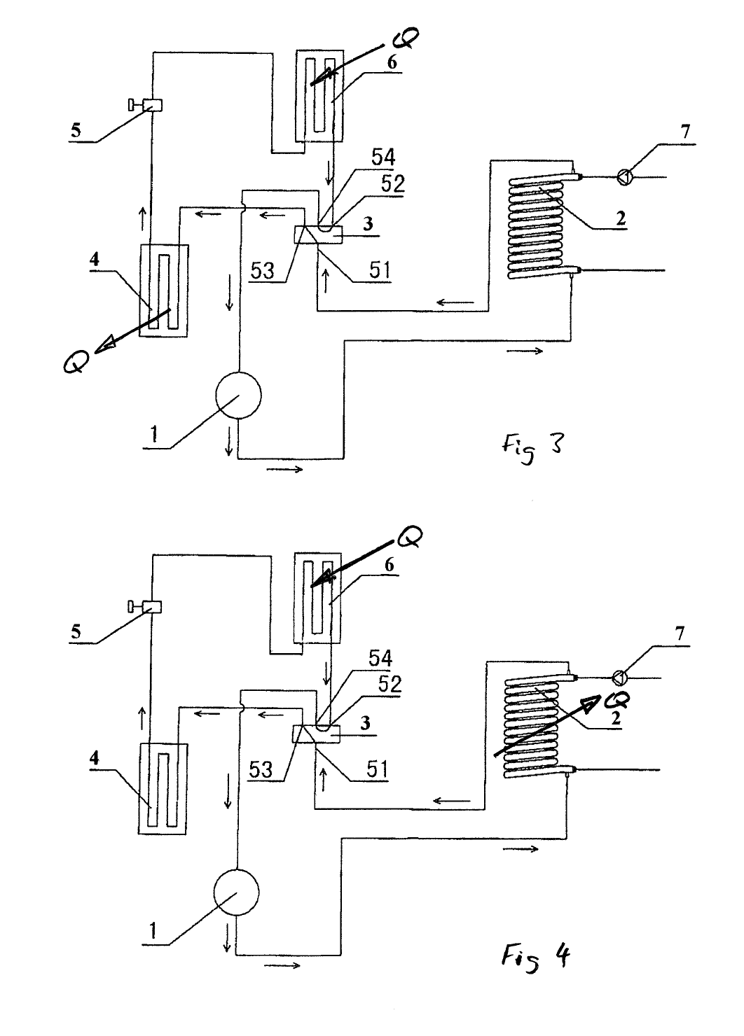

FIG. 2 illustrates the heat pump 10 in a first operating mode for cooling an inhabitable space. In this mode the valve 3 communicates port 51 to port 52, and port 53 to port 54 such that refrigerant from the first heat exchanger 2 passes through the second heat exchanger 6 then the third heat exchanger 4 before returning to the compressor 1.

The controller 8 stops the pump 2A to stop water flowing through the heat exchanger 2. In the absence of water flow, the water within the heat exchanger 2 quickly rises to match the refrigerant temperature whereby little or no heat exchange occurs between the water and refrigerant such that the heat exchanger two is effectively taken out of the fluid circuit 10A.

Thus hot, high pressure, gas from the compressor 1 is delivered to the second heat exchanger 6. The fan 6A is operated at its maximum speed to move ambient air through the heat exchanger 6 to accept heat from and to condense the refrigerant. Thus in this mode the second heat exchanger functions as a condenser.

From the second heat exchanger 6, the condensed, liquid, refrigerant passes through the expansion valve 5 and into the third heat exchanger 4. The fan 4A operates at full speed to drive air from inside the dwelling through the heat exchanger 4 to affect heat exchange with the refrigerant. Within the heat exchanger 4 the air is cooled and the refrigerant heated and caused to evaporate. Thus low pressure gaseous refrigerant leaves the third heat exchanger 4. This refrigerant passes via ports 53 and 54 of the valve 3 to the compressor 1.

FIG. 3 illustrates a second mode of operation in which the valve 3, in response to the control signals from the controller 8, is adjusted to reverse the direction of flow about the second portion of the fluid circuit 10A. The port 51 is communicated with the port 53 such that refrigerant from the first heat exchanger is delivered to the third heat exchanger. The port 52 is communicated with the port 54 such that refrigerant from this second heat exchanger 6 is returned to the compressor 1. To suit this reversal flow the expansion valve 5 is a bi-directional valve, capable of controlling flow in both directions. In this mode the fans 4A, 6A are each run at their full speed. In the third heat exchanger heat from the refrigerant is rejected to the air to heat the dwelling. In the second heat exchanger 6 the refrigerant accepts heat from the outside air.

FIG. 4 illustrates another mode of operation in which only water is heated. The pump 2A is activated to drive water through the first heat exchanger 2. The fan 4A is idle such that air within the heat exchanger 4 is in substance stationary and the heat exchanger 4 is effectively taken out of the fluid circuit 10A.

The pump speed is controlled, by the controller 8, in response to the water temperature as measured by the sensor 9D. The pump is controlled to increase the flow rate as the water temperature increases. In this example of the invention, if the water temperature is below 35° C. the pump is operated at 30% of its full speed. Between 35° C. and 43° C. the pump speed ramps up from 30% to 100%. Above 43° C. the pump operates at its full speed (100%).

In this example of the invention, including its specific set of refrigeration components (type and size of heat exchangers and compressor) the reduced water flow allows the system to increase condensing pressures and suction pressure, which results in better atmospheric heat absorption by the evaporator. High evaporator pressure also minimises frost of the evaporator coil.

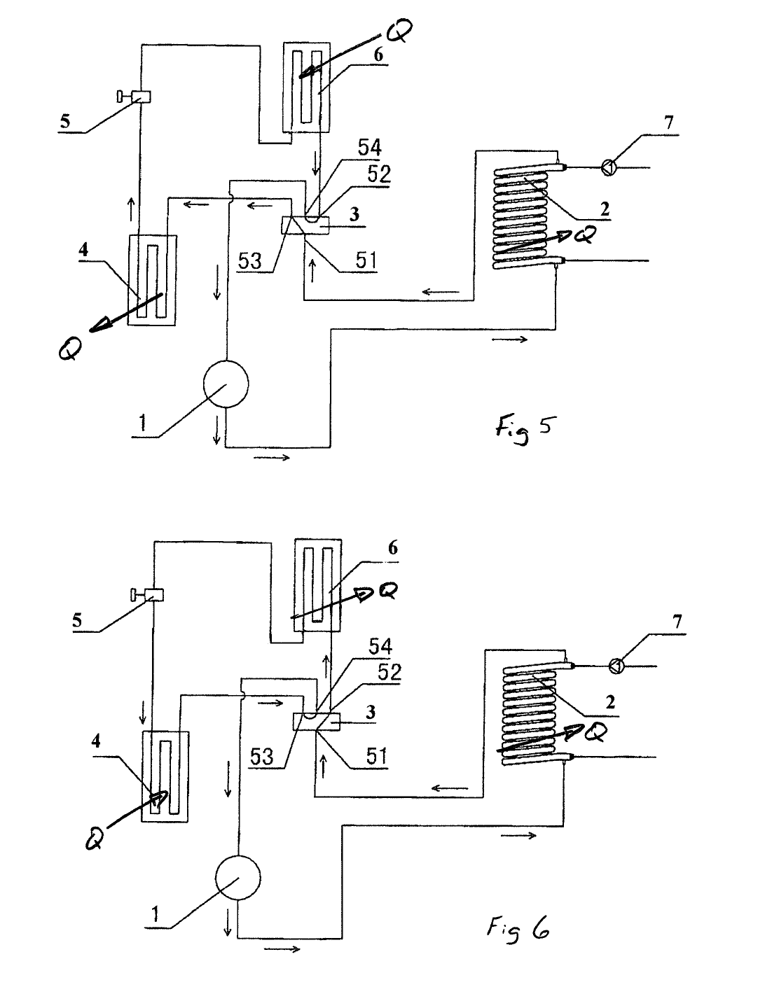

FIG. 5 illustrates another operating mode in which water and the inhabitable space are simultaneously heated. This mode of operation is relevantly similar to the mode of FIG. 4 except that the fan 4A is controlled in response to the refrigerant temperature. In this embodiment the fan 4A is controlled in response to the temperature as measured by the sensor 9A. Desirably the fan speed is increased as the measured temperature is increased, and/or the fan is activated when the measured temperature is above a predetermined threshold. In this example of the invention the fan 4A is idle when the measured temperature is at or below 38° C. Above 38° C. the fan is activated and run at its full speed.

In this mode, as the temperature of the water in the heat exchanger 2 increases, less heat is absorbed by the water allowing more to be put into the occupied space via heat exchanger 4.

FIG. 6 illustrates a further mode of operation in which the inhabitable space is cooled whilst the water is heated. In this mode of operation the valve 3 is set as in the mode of FIG. 2 such that the third heat exchanger 4 operates as an evaporator to cool the inhabitable space. The pump 2A is controlled in response to the water temperature as in the mode of FIGS. 4 and 5. It will be appreciated that heat drawn from the habitable environment is pumped to the water.

Additional heat may also be rejected to the external environment via the second heat exchanger 6. For this purpose the fan 6A is controlled in response to the refrigerant temperature. Preferably the fan speed increases as the refrigerant temperature increases, and/or the fan is activated when the refrigerant temperature is above a predetermined threshold. In this embodiment the temperature of the refrigerant is measured by sensor 9E immediately before it enters the second heat exchanger 6. The fan speed is modulated so that heat transferred to the water in this first heat exchanger 2 is maximised and the heat transferred to the environment through the second heat exchanger 6 is minimised. When the measured temperature is 50° C. or higher, the fan is operated at its maximum speed.

It in this mode of operation, in comparison to a conventional air-conditioner, the heat supplied to the hot water is free energy.

In each of the described modes the valve 5 dynamically adjusts in response to the controller 8 to control the temperature on the inlet side of the compressor 1 as measured by the temperature sensor 9A. The refrigerant is preferably superheated to at least 5° C. above its saturation temperature. For this purpose the valve 5 is electronic. In this example of the invention the orifice size of the valve 5 is adjustable between 600 different sizes, and the controller adjusts the size every 30 seconds. It is also contemplated that various non electronic valves, e.g. bi-metal valves, may be workable.

In the described example of the invention water is heated and/or air is heated and/or cooled. For this purpose the heat exchangers 4, 6 are communicated with respective bodies of air. This communication may be direct or indirect. By way of example air from either inside a dwelling or outside the dwelling may be ducted to the heat exchanger 4 and ducted from the heat exchanger 4 to the interior of the dwelling.

The invention is not limited to heating and/or cooling air. By way of example one or both of the heat exchangers 4, 6 may heat a stream of water or be communicated with a thermal mass for storing energy. A large body of water may be a suitable thermal mass. Alternatively energy may be stored in a phase change material.

The described heat pump desirably may include or cooperate with solar panels and batteries for storing electricity therefrom. In this case the controller desirably monitors the voltage in the batteries and periodically activates the driver (and other components as required) when the batteries have accumulated sufficient power for the efficient operation of the driver and the other components.

The described heat pump may be incorporated into an activatable energy storage device for installation in a residence. For this purpose the heat pump may include a communication arrangement for receiving control signals from a geographically distant controller. Optional the communication arrangement in integrated with controller 8. Power line communication (PLC) is a preferred mode of communication, although there are a wide range of other possibilities.

In a preferred method a centralized controller, which may be associated with a generator such as a gas turbine, may monitor the demand of electricity from a large number consumers. When an unexpected drop in demand occurs the controller sends an activation signal to the energy storage devices to cause the storage devices to consume additional energy. As such the additional energy resultant from the unexpected drop in demand may be stored at the consumer level for later use so as not to be wasted.

Of course it is also contemplated that control signals may be scheduled so as to coordinate the demand and supply for overall efficient operation of the power grid.

Preferably the energy storage devices store energy by heating water. In a rudimentary form of this aspect of the invention, the storage device may take the form of an otherwise conventional electric water heater (including a water tank internally carrying a resistive electric heating element) fitted with a controller including a suitable communication arrangement. The heater may be configured to maintain water at a first set point of, say, 60° C. and then in response to an activation signal heat the water to a higher set point of, say 80° C.

1. A heat pump including
a fluid circuit including
a first heat exchanger;
a second heat exchanger;
a third heat exchanger; and
a driver for driving fluid about the fluid circuit; and
a control arrangement having one or more modes of operation;
wherein
the first heat exchanger is arranged to exchange heat between the fluid of the fluid circuit and further fluid; and
the control arrangement is configured to in at least one of the modes of operation control a flow control mechanism to control a flow rate of the further fluid of the first heat exchanger.

2. The heat pump of claim 1 wherein the control of the flow rate of the further fluid of the first heat exchanger is dependent on a parameter characterising the further fluid of the first heat exchanger.

3. The heat pump of claim 2 wherein the parameter is temperature.

4. The heat pump of claim 2 wherein the control arrangement is configured to when in another mode of operation to substantially stop the flow of the further fluid of the first heat exchanger.

5. The heat pump of claim 1 wherein the control of the flow rate of the further fluid of the first heat exchanger is substantially stopping the flow of the further fluid of the first heat exchanger.

6. The heat pump of claim 1 further including a sensor, for sensing a parameter characterising the fluid of the fluid circuit, in communication with the control arrangement.

7. The heat pump of claim 6 wherein the parameter is temperature.

8. The heat pump of claim 6 wherein the control of the flow rate of the further fluid of the first heat exchanger is dependent upon the parameter.

9. The heat pump of claim 1
wherein the second heat exchanger is arranged to exchange heat between the fluid of the fluid circuit and further fluid; and
the control arrangement is configured to in at least one of the modes of operation control a flow control mechanism to control a flow rate of the further fluid of the second heat exchanger.

10. The heat pump of claim 9 wherein the control of the flow rate of the further fluid of the second heat exchanger is dependent on a or the parameter of the fluid of the fluid circuit.

11. The heat pump of claim 1 wherein the third heat exchanger is arranged to exchange heat between the fluid of the fluid circuit and further fluid; and the control arrangement is configured to in at least one of the modes of operation control a flow control mechanism to control a flow rate of the further fluid of the third heat exchanger.

12. The heat pump of claim 11 wherein the control of the flow rate of the further fluid of the third heat exchanger is dependent on a or the parameter of the fluid of the fluid circuit.

13. The heat pump of claim 1 wherein
the driver and the first heat exchanger are spaced along a first portion of the fluid circuit;
the second heat exchanger and the third heat exchanger are spaced along a second portion of the fluid circuit; and
the first and second fluid circuit portions are connected by a valve arrangement configured to, in response to the control arrangement, reverse a direction of flow about the second fluid circuit portion.

14. The heat pump of claim 1 including an expansion valve along the fluid circuit and between the second heat exchanger and the third heat exchanger.

15. The heat pump of claim 14 wherein the expansion valve is controlled by the control arrangement to maintain a temperature, of the fluid of the fluid circuit as it enters the driver, above a saturation temperature of the fluid of the fluid circuit.

16. The heat pump of claim 14 wherein the expansion valve is controlled by the control arrangement to maintain a temperature, of the fluid of the fluid circuit as it enters the driver, at or above about 5° C. above a saturation temperature of the fluid of the fluid circuit.

17. The heat pump of claim 1 wherein the further fluid of the first heat exchanger is water.

18. The heat pump of claim 1 wherein the further fluid of the second heat exchanger is air and the second heat exchanger is arranged to at least one of accept heat from and reject heat to an environment external to a dwelling.

19. The heat pump of claim 1 wherein the further fluid of the third heat exchanger is air and the third heat exchanger is arranged to at least one of heat and cool an interior of a or the dwelling.

20. The heat pump of claim 1 wherein the fluid of the fluid circuit is at least predominantly hydrocarbon.

21. The heat pump of claim 1 wherein the fluid of the fluid circuit is at least predominantly propane.

22. The heat pump of claim 1 further including one or more photovoltaic devices for powering the driver and the control arrangement.

23. The heat pump of claim 22 further including a device for storing electrical energy from the photo voltaic devices; wherein the control arrangement is configured to monitor the amount of energy stored in the device for storing electrical energy and activate the driver in response thereto.

24. The heat pump of claim 1 wherein the control arrangement is configured to monitor the amount of energy stored in a device for storing electrical energy from one or more photo voltaic devices activate the driver in response thereto.

25-26. (canceled)

27. A method of managing demand for electricity in an electricity supply system including one or more generators for supplying electricity to geographically spaced consumers of energy, the method including in response to a sensed or predicted reduction in demand from the consumers for electricity, activating energy storage devices associated with the consumers to consume electricity.

28. The method of claim 27 wherein the consumers include dwellings which each include one or more of the energy storage devices.

29. The method of claim 27 wherein one or more of the energy storage devices includes the heat pump.

30. The method of claim 27 wherein one or more of the energy storage devices are configured to heat water to store energy.

31. An energy storage device including a communication mechanism for receiving an activation signal from a geographically distal controller.

32. The device of claim 31 including the heat pump.

33. The device of claim 31 being configured to heat water to store energy.
